(19) United States
(12) Patent Application Publication
(10) Pub. No.: US 2014/0117616 A1
(43) Pub. Date: May 1, 2014

(54) CURRENCY TRANSMISSION APPARATUS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHIH-KUN SHIH, Santa Clara, CA (US); WAN-CHENG LUO, Shenzhen (CN); XIAO-MAO XIE, Shenzhen (CN); WEI XU, Shenzhen (CN); KAI-HUA WU, Shenzhen (CN); TAO HOU, Shenzhen (CN)

(21) Appl. No.: 13/947,377

(22) Filed: Jul. 22, 2013

(30) Foreign Application Priority Data
Oct. 30, 2012 (CN) 2012104235774

(51) Int. Cl. G07D 11/00

(52) U.S. Cl. CPC G07D 11/0021
USPC 271/264

(57) ABSTRACT

A currency transmission apparatus includes a bracket, an image scanner, and a rotating shaft. The bracket includes a guiding plate, which defines a number of cutouts. The image scanner is located below the guiding plate. A gap is defined between the guiding plate and the image scanner. The rotating shaft is pivotally mounted on the bracket. The rotating shaft includes a number of wheels. The wheels are located in the number of cutouts and are configured to rotate along the rotating shaft to move currency through the gap.

### BACKGROUND

1. Technical Field

The present disclosure generally relates to currency counting machines, and particularly to apparatuses used in currency counting machines for transmitting currency.

2. Description of Related Art

Vending machines have been in common use for dispensing many kinds of items to customers automatically after the customers insert currency into the machines. A vending machine typically includes a currency counter for counting the currency deposited by customers. However, if the currency is wrinkled or bent, it often gets blocked by the currency counter, so the currency cannot be transmitted.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a currency transmission apparatus in a currency counter.

FIG. 2 is an assembled view of the currency transmission apparatus of FIG. 1.

FIG. 3 is another assembled view of the currency transmission apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

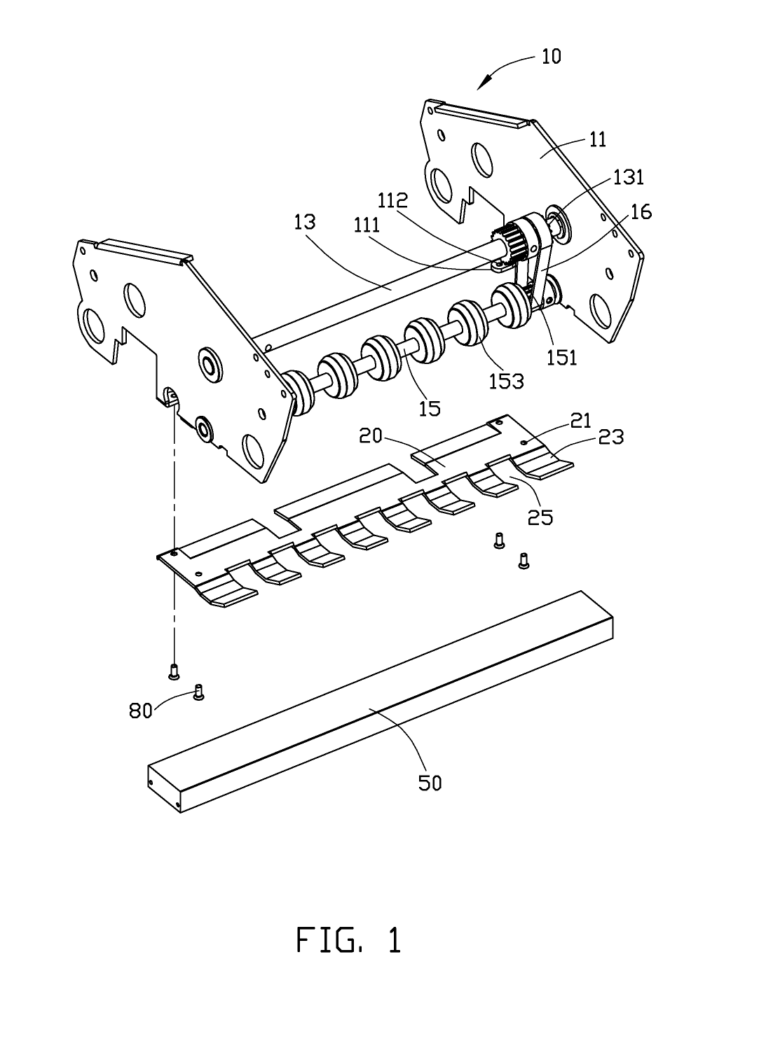

FIG. 1 shows an embodiment of a currency transmission apparatus. The currency transmission apparatus includes a bracket 10, a guiding plate 20, and an image scanner 50.

The bracket 10 includes a pair of mounting plates 11 and a driving axle 13 pivotally mounted between the pair of mounting plates 11. A first gear 131 is fixed on the driving axle 13. A rotating shaft 15 is pivotally mounted between the pair of mounting plates 11. The rotating shaft 15 is parallel to the driving axle 13 and located below the driving axle 13. A second gear 151 is fixed on the rotating shaft 15. A transmission belt 16 is wrapped around the first gear 131 and the second gear 151. The first gear 131 causes the second gear 151 to rotate via the transmission belt 16. A plurality of separated wheels 153 is mounted on the rotating shaft 15. A fixing piece 111 is connected substantially perpendicularly to a bottom edge of each mounting plate 11. Two fixing holes 112 are defined in each fixing piece 111.

The guiding plate 20 defines four through holes 21 corresponding to the fixing holes 112 of the bracket 10. The guiding plate 20 includes a plurality of separated guiding pieces 23. A cutout 25 is defined between two adjacent guiding pieces 23. The guiding pieces 23 are slightly titled upwards to allow currency to flow below.

The image scanner 50 is formed in a rectangular block.

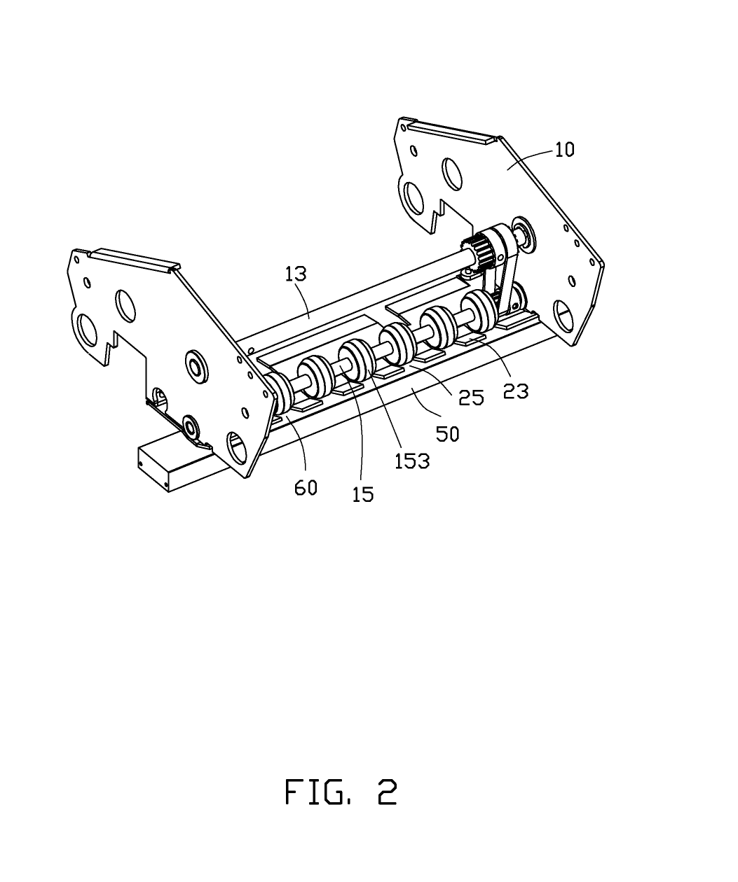

Referring to FIG. 2, in assembly, the through holes 21 of the guiding plate 20 are aligned with the fixing holes 112 of the bracket 10. A plurality of screws 80 secures the guiding plate 20 to the bracket 10 via the through holes 21 and the fixing holes 112. At this position, the plurality of wheels 153 on the rotating shaft 15 is located in the plurality of cutouts 25 of the guiding plate 20. The plurality of wheels 153 protrudes over a bottom side of the plurality of guiding pieces 23. Then, the image scanner 50 is mounted below the guiding plate 20. A gap 60 is defined between the guiding plate 20 and the image scanner 50 to allow currency to flow through.

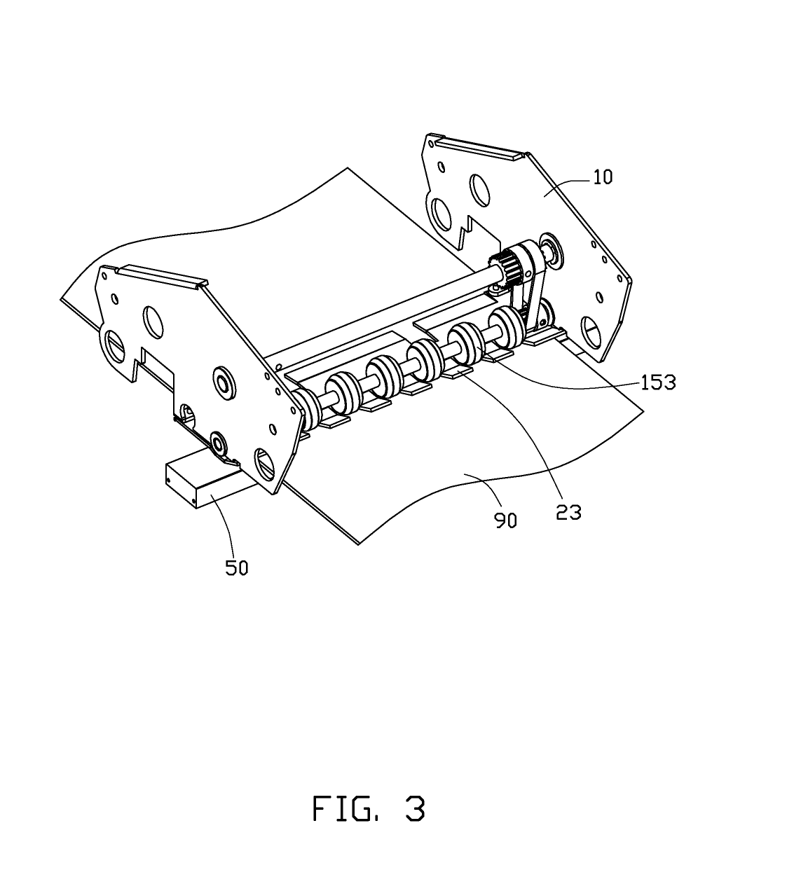

Referring to FIG. 3, in use, the currency 90 is transmitted through the gap 60. The image scanner 50 scans the currency 90 to get an image of the currency 90. Simultaneously, the driving axle 13 rotates, causing the shaft 15 to rotate via the first gear 131, the transmission belt 16, and the second gear 151. The wheels 153 of the rotating shaft 15 rotate to move the currency 90 through the gap 60. Therefore, even if the currency 90 is wrinkled or bent and is blocked by the image sensor 50, the currency 90 is still moved through the gap 60 by the wheels 153.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A currency transmission apparatus, comprising:
a bracket comprising a guiding plate, the guiding plate defining a cutout;
an image scanner located below the guiding plate, a gap being defined between the guiding plate and the image scanner; and
a rotating shaft pivotally mounted on the bracket, the rotating shaft comprising a wheel, wherein the wheel is located in the cutout, the wheel is configured to rotate along the rotating shaft and to drive currency to move in the gap.

2. The currency transmission apparatus of claim 1, wherein the bracket comprises a pair of mounting plates, and the rotating shaft is mounted between the pair of mounting plates.

3. The currency transmission apparatus of claim 2, wherein a driving axle is mounted between the pair of mounting plates, a first gear is fixed on the driving axle, a second gear is fixed on the rotating shaft, and a transmission belt is wrapped around the first gear and the second gear.

4. The currency transmission apparatus of claim 2, wherein each of the pair of mounting plates comprises a fixing piece, the fixing piece defines a fixing hole; the guiding plate defines a through hole, and the guiding plate is secured on the bracket by a screw mounted in the through hole and the fixing hole.

5. The currency transmission apparatus of claim 1, wherein the guiding plate comprises two guiding pieces located on opposite sides of the cutout.

6. The currency transmission apparatus of claim 5, where each of the two guiding pieces is slightly titled upwards to facilitate currency flowing below.

7. The currency transmission apparatus of claim 6, wherein the wheel protrudes over a bottom side of each of the two guiding pieces.

8. A currency transmission apparatus, comprising:
a bracket comprising a guiding plate, the guiding plate comprising a plurality of separated guiding pieces, and a cutout defined between each of the plurality of separated guiding pieces;
an image scanner located below the guiding plate, a gap being defined between the guiding plate and the image scanner; and
a rotating shaft pivotally mounted on the bracket, the rotating shaft comprising a plurality of wheels, wherein each of the plurality of wheels is located in the cutout, the plurality of wheels are configured to rotate along the rotating shaft and to drive currency to move through the gap.

9. The currency transmission apparatus of claim 8, wherein the bracket comprises a pair of mounting plates, and the rotating shaft is mounted between the pair of mounting plates.

10. The currency transmission apparatus of claim 9, wherein a driving axle is mounted between the pair of mounting plates, a first gear is fixed on the driving axle, a second gear is fixed on the rotating shaft, and a transmission belt is wrapped around the first gear and the second gear.

11. The currency transmission apparatus of claim 8, wherein each of the pair of mounting plates comprises a fixing piece, the fixing piece defines a fixing hole; the guiding plate defines a through hole, and the guiding plate is secured on the bracket by a screw mounted in the through hole and the fixing hole.

12. The currency transmission apparatus of claim 8, where each of the two guiding pieces is slightly titled upwards.

13. The currency transmission apparatus of claim 12, wherein each of the plurality of wheels protrudes over a bottom side of each of the plurality of guiding pieces.
